(19) United States
(12) Patent Application Publication
(10) Pub. No.: US 2022/0090752 A1
(43) Pub. Date: Mar. 24, 2022

(54) Automatic Driving Vehicle Luminaire and Automatic Driving Vehicle Lighting System

(71) Applicant: Toshiba Lighting & Technology Corporation, Yokosuka-shi (JP)

(72) Inventors: Daisuke Kosugi, Ehime-ken (JP); Ryuji Tsuchiya, Ehime-ken (JP)

(73) Assignee: Toshiba Lighting & Technology Corporation, Yokosuka-shi (JP)

(21) Appl. No.: 17/398,615

(22) Filed: Aug. 10, 2021

(30) Foreign Application Priority Data
Sep. 18, 2020 (JP) 2020-157347

(51) Int. Cl. F21S 41/176; F21V 23/06; F21S 45/47; F21S 41/143

(52) U.S. Cl. CPC F21S 41/176; F21S 41/143; F21S 45/47; F21V 23/06

(57) ABSTRACT

An automatic driving vehicle luminaire according to an embodiment displays a driving state of an automatic driving vehicle. The automatic driving vehicle luminaire includes: a socket; and a light-emitting module provided on one end side of the socket. The light-emitting module emits bluish green light.

### CROSS-REFERENCE TO RELATED APPLICATIONS

This application is based upon and claims the benefit of priority from Japanese Patent Application No. 2020-157347, filed on Sep. 18, 2020; the entire contents of which are incorporated herein by reference.

### FIELD

Embodiments described herein relate generally to an automatic driving vehicle luminaire and an automatic driving vehicle lighting system.

### BACKGROUND

From the viewpoints of energy saving and a long operational lifespan, a vehicle luminaire equipped with a light-emitting diode is becoming widespread instead of a vehicle luminaire equipped with a filament.

For example, the vehicle luminaire is used to visually recognize objects outside a vehicle by irradiating the outside of the vehicle with light as in a headlight, a fog lamp, and the like, or to visually recognize objects inside the vehicle by irradiating the inside of the vehicle with light as in a room lamp, a trunk lamp, and the like. In addition, the vehicle luminaire is used to notify persons outside the vehicle of existence of the vehicle as in a position lamp, a tail lamp, and the like, or to notify persons outside the vehicle of a driver's intension relating to driving of the vehicle as in a blinker, a back lamp, a stop lamp, and the like.

In addition, in recent years, development of an automatic driving vehicle is in progress. The automatic driving vehicle is also provided with a vehicle luminaire such as the above-described headlight used in the related art. Here, persons outside the vehicle can assume a driving state of the vehicle when a driver sits on a driver's seat. However, in the case of the automatic driving vehicle, driving of the vehicle may be performed even in a state in which the driver is absent on the driver's seat or a state in which a person is absent. In this case, when displaying a driving state of the automatic driving vehicle by using a vehicle luminaire used in the related art, there is a concern that misunderstanding of persons outside the vehicle may be caused.

Here, it is desired to develop a technology capable of accurately displaying the driving state of the automatic driving vehicle.

### DESCRIPTION OF THE DRAWINGS

FIG. 1 is a schematic perspective view illustrating a vehicle luminaire according to this embodiment.

FIG. 2 is a cross-sectional view taken along line A-A of the vehicle luminaire in FIG. 1.

FIG. 3 is an XY chromaticity diagram illustrating a color of light emitted from the vehicle luminaire.

FIG. 4 is a circuit diagram of the vehicle luminaire.

FIG. 5 is a graph illustrating voltage-current characteristics in a first light-emitting circuit and a second light-emitting circuit.

FIGS. 6A and 6B are schematic views illustrating an arrangement of a light-emitting element lighted in the first light-emitting circuit.

FIG. 7 is a schematic view illustrating an automatic driving vehicle lighting system.

### DETAILED DESCRIPTION

An automatic driving vehicle luminaire according to an embodiment displays a driving state of an automatic driving vehicle. The automatic driving vehicle luminaire includes a socket, and a light-emitting module provided on one end side of the socket. The light-emitting module emits bluish green light.

Hereinafter, an embodiment will be described with reference to the accompanying drawings. Note that, in the drawings, the same reference numeral will be given to the same constituent element, and detailed description thereof will be appropriately omitted.

(Automatic Driving Vehicle Luminaire)

An automatic driving vehicle luminaire 1 (hereinafter, simply referred to as “vehicle luminaire 1”) according to this embodiment displays a driving state of an automatic driving vehicle. For example, the vehicle luminaire 1 can be installed in an automobile, a railway vehicle, and the like which perform automatic driving. For example, the vehicle luminaire 1 that is provided in the automobile can be attached to a lighting tool such as a front combination light and a rear combination light, can be attached to a lighting tool provided in a vehicle body such as bonnet, a roof, a pillar, a bumper, and a fender, or can be attached to a lighting tool provided in a rearview mirror or the like. Note that, the installation position of the vehicle luminaire 1 is not limited to the exemplified positions, and may be a position that can be visually recognized by persons outside the vehicle.

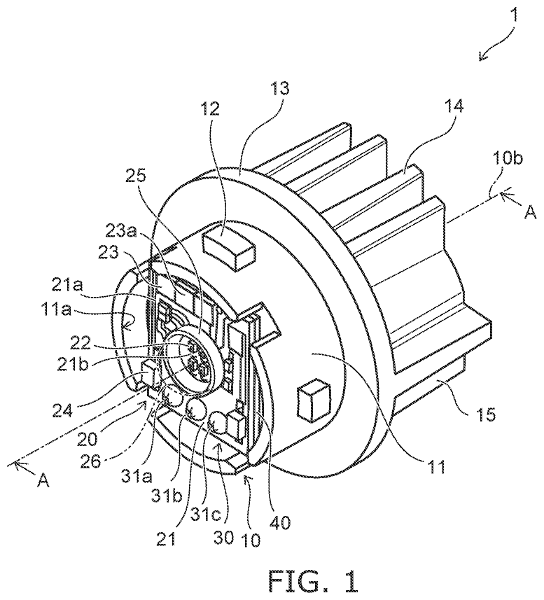

FIG. 1 is a schematic perspective view illustrating the vehicle luminaire 1 according to this embodiment.

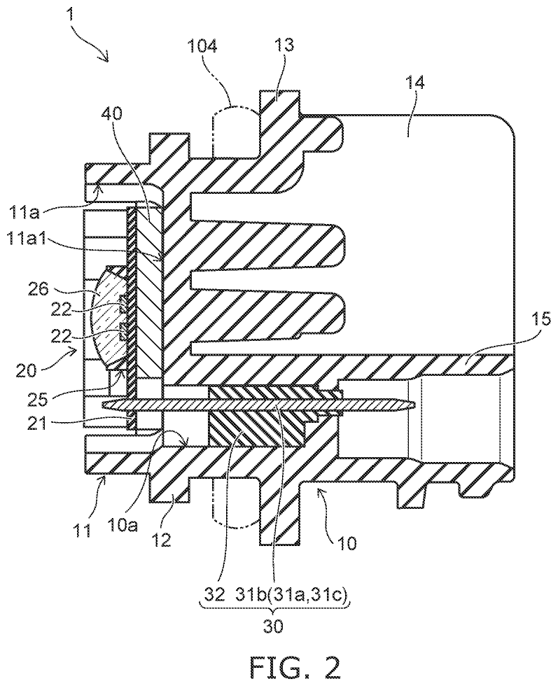

FIG. 2 is a cross-sectional view taken along line A-A of the vehicle luminaire 1 in FIG. 1.

As illustrated in FIG. 1 and FIG. 2, for example, a socket 10, a light-emitting module 20, a power-supply part 30, and a heat transfer part 40 are provided in the vehicle luminaire 1.

For example, the socket 10 includes a mounting part 11, a bayonet 12, a flange 13, a thermal radiation fin 14, and a connector holder 15.

The mounting part 11 can be provided on a surface of the flange 13 which is opposite to a side in which the thermal radiation fin 14 is provided. An external shape of the mounting part 11 can be set to a columnar shape. For example, the external shape of the mounting part 11 is a circular column shape. The mounting part 11 can include a concave part 11a that is opened to an end on a side opposite to the flange 13 side.

The bayonet 12 can be provided on an outer surface of the mounting part 11. For example, the bayonet 12 protrudes toward an outer side of the vehicle luminaire 1. The bayonet 12 can be set to face the flange 13. A plurality of the bayonets 12 can be provided. The bayonet 12 can be used, for example, when mounting the vehicle luminaire 1 to a housing 101 of a vehicle lighting tool 100 to be described later. The bayonet 12 can be used for twist lock.

The flange 13 can be set to have a plate shape. For example, the flange 13 can be set to have a disk shape. An outer surface of the flange 13 can be located on an outer side of the vehicle luminaire 1 in comparison to an outer surface of the bayonet 12.

The thermal radiation fin 14 can be provided on a side of the flange 13 which is opposite to the mounting part 11 side. As the thermal radiation fin 14, at least one piece can be provided. For example, a plurality of the thermal radiation fins 14 are provided in the socket 10 illustrated in FIG. 1. The plurality of thermal radiation fins 14 can be provided in parallel in a predetermined direction. The thermal radiation fins 14 can be set to have a plate shape.

The connector holder 15 can be provided on a side of the flange 13 which is opposite to the mounting part 11 side. The connector holder 15 can be provided in parallel to the thermal radiation fins 14. The connector holder 15 can be provided in the vicinity of a peripheral edge of the flange 13. The connector holder 15 has a tubular shape, and a connector 105 including a sealing member 105a can be inserted into the connector holder 15.

The socket 10 has a function of holding the light-emitting module 20 and the power-supply part 30, and a function of transferring heat generated in the light-emitting module 20 to the outside. Accordingly, it is preferable that the socket 10 is formed from a material having high heat conductivity. For example, the socket 10 can be formed from a metal such as an aluminum alloy.

In addition, in recent years, the socket 10 is desired to efficiently radiate heat generated in the light-emitting module 20 and to be light in weight. Accordingly, the socket 10 is preferably formed from a highly heat conductive resin. For example, the highly heat conductive resin includes a resin and a filler using an inorganic material. For example, the highly heat conductive resin can be set as a material obtained by mixing a filler using carbon or aluminum oxide in a resin such as polyethylene terephthalate (PET) and nylon.

When the socket 10 contains the highly heat conductive resin, and the mounting part 11, the bayonet 12, the flange 13, the thermal radiation fins 14, and the connector holder 15 are integrally formed, heat generated in the light-emitting module 20 can be efficiently radiated. In addition, the weight of the socket 10 can be reduced. In this case, the mounting part 11, the bayonet 12, the flange 13, the thermal radiation fins 14, and the connector holder 15 can be integrally formed by using an injection molding method or the like. In addition, the socket 10 and the power-supply part 30 can also be integrally formed by using an insert molding method or the like.

For example, the power-supply part 30 includes a power-supply terminal 31a (corresponding to an example of a first power-supply terminal), a power-supply terminal 31b, a power-supply terminal 31c (corresponding to an example of a second power-supply terminal), and a holding part 32.

As to be described later, a first light-emitting circuit 20a and a second light-emitting circuit 20b are provided in the vehicle luminaire 1 (light-emitting module 20) according to this embodiment, and a ground is common to the first light-emitting circuit 20a and the second light-emitting circuit 20b (refer to FIG. 4). Accordingly, the power-supply terminals 31a to 31c are provided as illustrated in FIG. 1. In the following description, as an example, a case where the power-supply terminals 31a to 31c are provided is exemplified, but the number of the power-supply terminals can be appropriately changed in correspondence with the number of light-emitting circuits, a use aspect of the ground, or the like.

The power-supply terminals 31a to 31c can be set as a rod-shaped body. One ends of the power-supply terminals 31a to 31c protrude from a bottom surface 11a1 of the concave part 11a. The power-supply terminals 31a to 31c can be provided in parallel in a predetermined direction. The one ends of the power-supply terminals 31a to 31c are soldered to a wiring pattern 21a provided on a board 21. The other ends of the power-supply terminals 31a to 31c are exposed to the inside of a hole of the connector holder 15. The connector 105 can be fitted to the power-supply terminals 31a to 31c exposed to the inside of the hole of the connector holder 15. For example, the power-supply terminals 31a to 31c can be formed from a metal such as a copper alloy. Note that, the shape, the arrangement, the material, and the like of the power-supply terminals 31a to 31c are not limited to the exemplified configurations, and can be appropriately changed.

As described above, it is preferable that the socket 10 is formed from a material having high heat conductivity. However, the material having high heat conductivity may have electric conductivity. For example, a metal such as an aluminum alloy, a highly heat conductive resin including a filler formed from carbon, and the like have electric conductivity. Accordingly, the holding part 32 is provided for insulation between the power-supply terminals 31a to 31c and the socket 10 having electric conductivity. In addition, the holding part 32 also has a function of holding the power-supply terminals 31a to 31c. Note that, when the socket 10 is formed from a highly heat conductive resin (for example, a highly heat conductive resin containing a filler formed from an aluminum oxide, or the like) having insulation properties, the holding part 32 can be omitted. In this case, the socket 10 holds the power-supply terminals 31a to 31c. The holding part 32 can be formed from a resin having insulating properties. For example, the holding part 32 can be pressed into a hole 10a provided in the socket 10, or can be bonded to an inner wall of the hole 10a.

For example, the heat transfer part 40 is provided between the board 21 and the bottom surface 11a1 of the concave part 11a. For example, the heat transfer part 40 can be bonded to the bottom surface 11a1 of the concave part 11a. As an adhesive that bonds the heat transfer part 40 and the bottom surface 11a1 of the concave part 11a, an adhesive having high heat conductivity is preferable. For example, the adhesive can be set as an adhesive in which a filler using an inorganic material is mixed. It is preferable that the inorganic material is set as a material (for example, ceramics such as aluminum oxide and aluminum nitride) having high heat conductivity. For example, the heat conductivity of the adhesive can be set to 0.5 to 10 W/(m·K).

In addition, the heat transfer part 40 can also be embedded in the bottom surface 11a1 of the concave part 11a by an insert molding method. In addition, the heat transfer part 40 can also be mounted on the bottom surface 11a1 of the concave part 11a through a layer formed from heat conductive grease (thermal radiation grease). There is no particular limitation to the kind of the heat conductive grease, but the heat conductive grease can be set as grease obtained by mixing a filler using a material (for example, ceramics such as aluminum oxide and aluminum nitride) having high heat conductivity, for example, in modified silicone. For example, the heat conductivity of the heat conductive grease can be set to 1 to 5 W/(m·K).

The heat transfer part 40 is provided in order for heat generated in the light-emitting module 20 to be easily transferred to the socket 10. Accordingly, it is preferable that the heat transfer part 40 is formed from a material having high heat conductivity. The heat transfer part 40 has a plate shape, and can be formed from, for example, a metal such as aluminum, an aluminum alloy, copper, and a copper alloy.

Note that, when heat generated in the light-emitting module 20 is less, the heat transfer part 40 can also be omitted.

For example, the light-emitting module 20 includes the board 21, a light-emitting element 22, a resistor 23, a current control unit 23a, a control element 24, a frame part 25, and a sealing part 26.

For example, the board 21 can be bonded onto the heat transfer part 40. In this case, it is preferable that an adhesive is set as an adhesive having high heat conductivity. For example, the adhesive can be the same as the above-described adhesive that bonds the heat transfer part 40 and the bottom surface 11a1 of the concave part 11a.

For example, the board 21 can be formed from an inorganic material such as ceramics (for example, aluminum oxide, aluminum nitride, and the like), an organic material such as paper phenol and glass epoxy, or the like. In addition, the board 21 may be a member obtained by coating a surface of a metal plate with an insulating material. When the amount of heat generation in the light-emitting element 22 is large, from the viewpoint of thermal radiation, it is preferable that the board 21 is formed by using a material with high heat conductivity. Examples of the material having high heat conductivity include ceramics such as aluminum oxide and aluminum nitride, a highly heat conductive resin, a member obtained by coating a surface of a metal plate with an insulating material, and the like. In addition, the board 21 may have a single-layer structure, or a multi-layer structure.

In addition, the wiring pattern 21a is provided on a surface of the board 21. For example, the wiring pattern 21a can be formed from a material containing silver as a main component, a material containing copper as a main component, or the like.

A plurality of the light-emitting elements 22 are provided on a side of the board 21 which is opposite to the bottom surface 11a1 side of the concave part 11a. The plurality of light-emitting elements 22 are electrically connected to the wiring pattern 21a provided on the surface of the board 21.

For example, the plurality of light-emitting elements 22 can be set as a light-emitting diode, an organic light-emitting diode, a laser diode, or the like.

The plurality of light-emitting elements 22 can also be set as a chip-shaped light-emitting element, a surface mounting type light-emitting element such as a plastic leaded chip carrier (PLCC) type, a shell type light-emitting element including a lead wire, or the like. The light-emitting elements 22 illustrated in FIG. 1 and FIG. 2 are chip-shaped light-emitting elements. In this case, the chip-shaped light-emitting elements are preferable when considering a reduction in size of the light-emitting module 20, and a reduction in size of the vehicle luminaire 1. Hereinafter, as an example, description will be given of a case where each of the light-emitting elements 22 is the chip-shaped light-emitting element.

The chip-shaped light-emitting elements 22 can be mounted by chip on board (COB). For example, the chip-shaped light-emitting elements 22 can be set as upper electrode type light-emitting elements, vertical type light-emitting elements, flip-chip type light-emitting elements, or the like. The chip-shaped light-emitting elements 22 illustrated in FIG. 1 and FIG. 2 are the vertical electrode type light-emitting elements. Electrodes of the upper electrode type light-emitting elements or upper electrodes of the vertical electrode type light-emitting elements can be electrically connected to the wiring pattern 21a by a wiring 21b. In this case, connection of the wiring 21b can be established, for example, by a wire bonding method. The flip-chip type light-emitting elements 22 can be directly mounted on the wiring pattern 21a.

The resistor 23 is provided on a side of the board 21 which is opposite to the bottom surface 11a1 side of the concave part 11a. The resistor 23 is electrically connected to the wiring pattern 21a provided on the surface of the board 21. The resistor 23 can be connected to each of the light-emitting elements 22 in series. For example, the resistor 23 can be set as a surface mounting type resistor, a resistor (resistor coated with a metal oxide) including a lead wire, a film-shaped resistor formed by using a screen printing method or the like, or the like. Note that, the resistor 23 illustrated in FIG. 1 is the film-shaped resistor.

For example, a material of the film-shaped resistor can be set as ruthenium oxide (RuO₂). For example, the film-shaped resistor can be formed by a screen printing method, and a firing method. When the resistor 23 is the film-shaped resistor, a contact area between the resistor 23 and the board 21 can be enlarged, and thus thermal radiation characteristics can be improved. In addition, a plurality of the resistors 23 can be formed at a time. Accordingly, productivity can be improved. In addition, a deviation of a resistance value in the plurality of resistors 23 can be suppressed.

Here, since a variation exists in forward voltage characteristics of the light-emitting elements 22, when an application voltage between an anode terminal and a ground terminal is made constant, a variation occurs in brightness (luminous flux, luminance, luminous intensity, or illuminance) of light emitted from the light-emitting elements 22. Accordingly, a value of a current flowing through the light-emitting elements 22 is made to be within a predetermined range by the resistor 23 so that brightness of light emitted from the light-emitting elements 22 is within a predetermined range. In this case, the value of the current flowing through the light-emitting elements 22 is made to be within the predetermined range by causing the resistance value of the resistor 23 to vary.

When the resistor 23 is the surface mounting type resistor, the resistor including the lead wire, or the like, a resistor 23 having an appropriate resistance value in correspondence with the forward voltage characteristics of the light-emitting elements 22 is selected. When the resistor 23 is the film-shaped resistor, if removing a part of the resistor 23, the resistance value can be increased. For example, a part of the resistor 23 can be easily removed by irradiating the resistor 23 with laser light. The number, a size, an arrangement, and the like of the resistor 23 are not limited to the exemplification, and can be appropriately changed in correspondence with the number, specifications, and the like of the light-emitting elements 22.

In addition, a constant-current circuit can also be provided instead of the resistor 23. For example, the constant-current circuit can be set as a mirror circuit, a constant-current circuit using a constant-current diode, a current limiter circuit using a transistor, a constant-current IC, or the like. When the constant-current circuit is provided, a current flowing through the light-emitting elements 22 can be made approximately constant even though an input voltage fluctuates.

The current control unit 23a can be provided in place of the resistor 23. When a plurality of light-emitting circuits are provided, the current control unit 23a and the resistor 23 can be selected as necessary. Note that, the current control unit 23a and the resistor 23 may be provided in only one light-emitting circuit. For example, the current control unit 23a can be provided in the first light-emitting circuit 20a to be described later, and the resistor 23 can be provided in the second light-emitting circuit 20b.

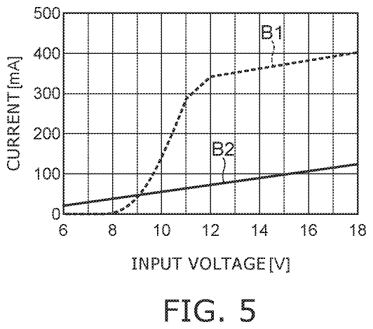

For example, the current control unit 23a can be configured to control a value of a current flowing through the light-emitting elements 22 and a luminous flux of light emitted from the light-emitting elements 22 in correspondence with an application voltage. In this case, the current control unit 23a can be set as a constant-current control circuit or the like. In this case, control of a luminous flux becomes easy. Note that, details relating to the control of the luminous flux will be described later (refer to FIG. 4 and FIG. 5).

The control element 24 is provided on a side of the board 21 which is opposite to the bottom surface 11a1 side of the concave part 11a. The control element 24 is electrically connected to the wiring pattern 21a provided on the surface of the board 21. The control element 24 is provided to prevent a reverse voltage from being applied to the light-emitting elements 22, and to prevent a pulse noise from a reverse direction from being applied to the light-emitting elements 22. For example, the control element 24 can be set as a diode. For example, the control element 24 can be set as a surface mounting type diode, a diode including a lead wire, or the like. The control element 24 illustrated in FIG. 1 is the surface mounting type diode.

In addition, a pull-down resistor can also be provided to detect conduction relating to the light-emitting elements 22, to prevent erroneous lighting, or the like. In addition, a positive characteristic thermistor can also be provided to suppress temperature rise in the light-emitting elements 22. In addition, a capacitor, a negative characteristic thermistor, a surge absorber, a varistor, a transistor such as FET, an integration circuit, an arithmetic element, and the like can also be appropriately provided as necessary.

In addition, a covering part that covers the wiring pattern 21a, the film-shaped resistor, or the like can also be provided. For example, the covering part can be set to contain a glass material.

The frame part 25 is provided on a side of the board 21 which is opposite to the bottom surface 11a1 side of the concave part 11a. The frame part 25 has a frame shape, and is bonded onto the board 21. The plurality of light-emitting elements 22 are arranged in a region surrounded by the frame part 25. The frame part 25 can be formed from a resin. Examples of the resin include thermoplastic resins such as polybutylene terephthalate (PBT), polycarbonate (PC), PET, nylon, polypropylene (PP), polyethylene (PE), and polystyrene (PS).

The frame part 25 has a function of defining a formation range of the sealing part 26, and a function as a reflector. Accordingly, the frame part 25 may contain particles of titanium oxide, or may contain a white resin to improve reflectance.

The sealing part 26 is provided to cover the region surrounded by the frame part 25. The sealing part 26 covers the light-emitting elements 22, the wiring 21b, and the like. The sealing part 26 can be formed from a material having translucency. For example, the sealing part 26 can be formed by filling the region surrounded by the frame part 25 with a resin. For example, filling with the resin can be performed by using a dispenser or the like. For example, the filled resin can be set as a silicone resin, or the like.

In addition, only the sealing part 26 can be provided without the frame part 25. When only the sealing part 26 is provided, the sealing part 26 having a dome shape is provided on the board 21.

Here, various luminaires are installed already in a vehicle. Accordingly, it is preferable that the vehicle luminaire 1 that displays a driving state of an automatic driving vehicle emits light having a color different from a color of light emitted from the luminaires installed already in the vehicle. For example, it is preferable that a color of light emitted from the vehicle luminaire 1 is set to a color other than red, amber, and white. In addition, it is preferable that the color of the light emitted from the vehicle luminaire 1 is set to a color that is easy to visually confirm with eyes of persons outside the vehicle.

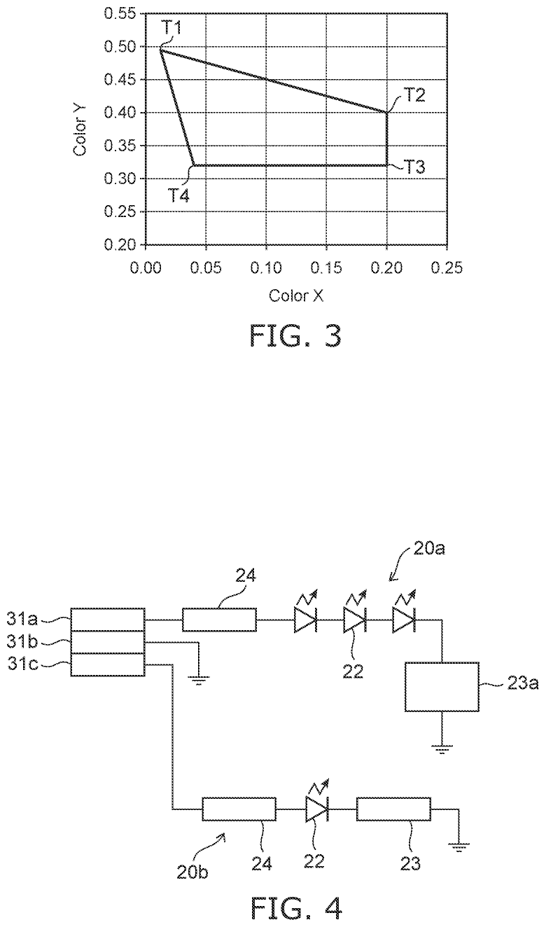

FIG. 3 is an XY chromaticity diagram illustrating the color of the light emitted from the vehicle luminaire 1. In FIG. 3, it is preferable that the color of the light emitted from the vehicle luminaire 1 is set as a color in a region surrounded by a line connecting chromaticity coordinates T1 and chromaticity coordinates T2, a line connecting the chromaticity coordinates T2 and chromaticity coordinates T3, a line connecting the chromaticity coordinates T3 and chromaticity coordinates T4, and a line connecting the chromaticity coordinates T4 and the chromaticity coordinates T1. Persons outside the vehicle can easily recognize the color included in the region without misunderstanding, and thus the driving state of the automatic driving vehicle can be accurately displayed.

In this case, the chromaticity coordinates T1 can be set to (0, 0.55), and preferably (0.012, 0.495).

The chromaticity coordinates T2 can be set to (0.25, 0.45), and preferably (0.2, 0.4).

The chromaticity coordinates T3 can be set to (0.25, 0.27), and preferably (0.2, 0.32).

The chromaticity coordinates T4 can be set to (0, 0.27), and preferably (0.04, 0.32).

Examples of the color included in the region include bluish green (also referred to as turquoise blue or the like). In this case, the light-emitting elements 22 are set as a blue light-emitting diode, and a phosphor is mixed in the sealing part 26 to emit bluish green light. In addition, a phosphor sheet containing the phosphor may be adhered to a light-emitting surface of the light-emitting elements 22. As the phosphor, for example, a phosphor obtained by mixing a blue light-emitting phosphor and a green light-emitting phosphor can be used. In addition, a bluish green light-emitting phosphor can also be used. For example, the green light-emitting phosphor can be set as a halophosphate phosphor that contains an alkaline earth metal, phosphoric acid, halogen, and europium as constituent elements. In addition, light-emitting elements 22 which emit bluish green light without using the phosphor can also be used. Description was given of the case of the chip-shaped light-emitting element, but this can also be true of the surface mounting type light-emitting element.

That is, the vehicle luminaire 1 includes the light-emitting module 20 provided on one end side of the socket 10. The light-emitting module 20 emits bluish green light.

In addition, the vehicle luminaire 1 may be lighted in a bright environment, or may be lighted in a dark environment. For example, the vehicle luminaire 1 may be lighted in the daytime on a sunny day, or may be lighted at night, or in a tunnel or the like.

In this case, when assuming that the luminous flux of light emitted from the vehicle luminaire 1 is approximately constant, there is a concern that it may be difficult for persons outside the vehicle to recognize the light, or the persons outside the vehicle may feel a sense of discomfort. For example, when the luminous flux is set to a luminous flux at which persons outside the vehicle does not feel a sense of discomfort in a dark environment, it is difficult for persons outside the vehicle to recognize a lighting state in a bright environment. When the luminous flux is set to a luminous flux at which persons outside the vehicle easily recognize the lighting state in a bright environment, persons outside the vehicle may feel a sense of discomfort in a dark environment.

Here, the vehicle luminaire 1 according to this embodiment is configured to switch the luminous flux of emitted light.

FIG. 4 is a circuit diagram of the vehicle luminaire 1.

As illustrated in FIG. 4, for example, the first light-emitting circuit 20a and the second light-emitting circuit 20b can be provided in the vehicle luminaire 1.

For example, the first light-emitting circuit 20a includes the control element 24, the plurality of light-emitting elements 22 (corresponding to an example of a first light-emitting element) connected to each other in series, and the current control unit 23a. The control element 24, the plurality of light-emitting elements 22, and the current control unit 23a are connected in series. Note that, three light-emitting elements 22 connected in series are provided in the first light-emitting circuit 20a illustrated in FIG. 4. An anode side of the first light-emitting circuit 20a is electrically connected to the power-supply terminal 31a. A ground side of the first light-emitting circuit 20a is electrically connected to the power-supply terminal 31b.

For example, the second light-emitting circuit 20b includes the control element 24, at least one light-emitting element 22 (corresponding to an example of a second light-emitting element), and the resistor 23. The second light-emitting circuit 20b includes a smaller number of light-emitting elements 22 in comparison to the first light-emitting circuit 20a. One light-emitting element 22 is provided in the second light-emitting circuit 20b illustrated in FIG. 4. The control element 24, the light-emitting element 22, and the resistor 23 are connected in series. An anode side of the second light-emitting circuit 20b is electrically connected to the power-supply terminal 31c. A ground side of the second light-emitting circuit 20b is electrically connected to the power-supply terminal 31b. That is, the power-supply terminal 31b is a ground terminal common to the first light-emitting circuit 20a and the second light-emitting circuit 20b.

For example, when the vehicle luminaire 1 is lighted in an environment in which the outside of the vehicle is dark (corresponding to an example of first brightness), a voltage is applied to the power-supply terminal 31c, and a voltage is not applied to the power-supply terminal 31a. In this case, since a current does not flow through the plurality of light-emitting elements 22 provided in the first light-emitting circuit 20a, and a current flows through the light-emitting element 22 provided in the second light-emitting circuit 20b, a luminous flux of light emitted from the vehicle luminaire 1 can be reduced. When the luminous flux of the light emitted from the vehicle luminaire 1 is reduced, even in a dark environment, it is possible to suppress persons outside the vehicle from feeling a sense of discomfort when the vehicle luminaire 1 is lighted.

For example, when the vehicle luminaire 1 is lighted in an environment in which the outside of the vehicle is bright (corresponding to an example of second brightness), a voltage is applied to the power-supply terminal 31a, and a voltage is not applied to the power-supply terminal 31c. In this case, since a current flows through the plurality of light-emitting elements 22 provided in the first light-emitting circuit 20a, the luminous flux of light emitted from the vehicle luminaire 1 can be increased. In addition, a voltage may also be applied to the power-supply terminal 31a and the power-supply terminal 31c. When a voltage is applied to the power-supply terminal 31a and the power-supply terminal 31c, since a current flows through all of the light-emitting elements 22 provided in the vehicle luminaire 1, the luminous flux of light emitted from the vehicle luminaire 1 can be increased. When increasing the luminous flux of the light emitted from the vehicle luminaire 1, it is easy for persons outside the vehicle to visually recognize lighting of the vehicle luminaire 1 even in a bright environment.

In addition, in the dark environment, even when the luminous flux is small, it is easy for persons outside the vehicle to visually recognize lighting of the vehicle luminaire 1. In addition, in the dark environment, the brightness rarely varies significantly. On the other hand, in the bright environment, when the luminous flux is insufficient, it may be difficult for persons outside the vehicle to visually recognize lighting of the vehicle luminaire 1. In addition, in the bright environment, the brightness may vary significantly in many cases. For example, on rainy days and sunny days, in the morning, at night, at daytime, and the like the brightness may vary significantly. Here, the current control unit 23a can be provided in the first light-emitting circuit 20a. The current control unit 23a is connected to the plurality of light-emitting elements 22 in series. The current control unit 23a controls a value of a current flowing through the plurality of light-emitting elements 22 in correspondence with a voltage applied to the power-supply terminal 31a.

FIG. 5 is a graph illustrating voltage-current characteristics in the first light-emitting circuit 20a and the second light-emitting circuit 20b.

Note that, B1 in FIG. 5 corresponds to the case of the first light-emitting circuit 20a. B2 in FIG. 5 corresponds to the case of the second light-emitting circuit 20b.

Since the resistor 23 is provided in the second light-emitting circuit 20b, as indicated by B2 in FIG. 5, when an application voltage increases, a current flowing through the light-emitting elements 22 increases approximately in proportion to the increase. In addition, an increase in current also becomes gradual.

In contrast, since the current control unit 23a is provided in the first light-emitting circuit 20a, as indicated by B1 in FIG. 5, in a region in which a voltage applied to the light-emitting module 20 during vehicle operation is 12 to 15 V, a variation in brightness can be made small, and deterioration of visibility due to flickering or the like can be prevented.

Hereinbefore, description was given of a case where the vehicle luminaire 1 is lighted, but the vehicle luminaire 1 can be blinked, a period of the blinking can be caused to vary, brightness can be caused to vary, or the blinking and the variation of brightness can also be combined. In this case, the variation of brightness can be carried out by switching of the first light-emitting circuit 20a and the second light-emitting circuit 20b, or the like. In addition, the variation of brightness can also be performed by the current control unit 23a.

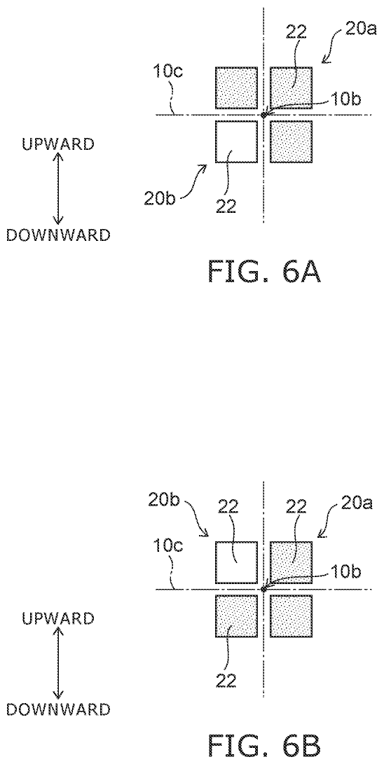

FIGS. 6A and 6B are schematic views illustrating an arrangement of the light-emitting elements 22 lighted in the first light-emitting circuit 20a. Note that, FIGS. 6A and 6B correspond to a case where three light-emitting elements 22 are provided in the first light-emitting circuit 20a.

When the vehicle luminaire 1 is attached to a lighting tool such as front combination light and a rear combination light, a central axis 10b of the socket 10 may face a horizontal direction. In this case, as illustrated in FIGS. 6A and 6B, the three light-emitting elements 22 are provided on an upward side and a downward side of an approximately horizontal line segment 10c passing through the central axis 10b. When the light-emitting elements 22 are lighted, heat generated in the light-emitting elements 22 is likely to be transferred to a region of the thermal radiation fin 14 which is located on an upward side of the lighted light-emitting elements 22, but the heat is less likely to be transferred to a region located on a downward side. When the number of lighted light-emitting elements 22 increases, the amount of heat generated increases, and thus it is preferable that heat is likely to be transferred to a wide region of the thermal radiation fin 14 as much as possible.

For example, as illustrated in FIG. 6A, when the number of the light-emitting elements 22 located on the downward side of the line segment 10c is smaller than the number of light-emitting elements 22 located on the upward side of the line segment 10c, the amount of heat transferred to a region of the thermal radiation fin 14 which is located on the downward side of the line segment 10c decreases.

In contrast, as illustrated in FIG. 6B, when the number of the light-emitting elements 22 located on the downward side of the line segment 10c is larger than the number of the light-emitting elements 22 located on the upward side of the line segment 10c, the amount of heat transferred to the region of the thermal radiation fin 14 which is located on the downward side of the line segment 10c increases. Heat transferred to the region of the thermal radiation fin 14 which is located on the downward side of the line segment 10c propagates toward the upward side of the thermal radiation fin 14, and thus heat can be radiated from a wider region of the thermal radiation fin 14.

(Automatic Driving Vehicle Lighting System)

Next, an automatic driving vehicle lighting system 200 will be described.

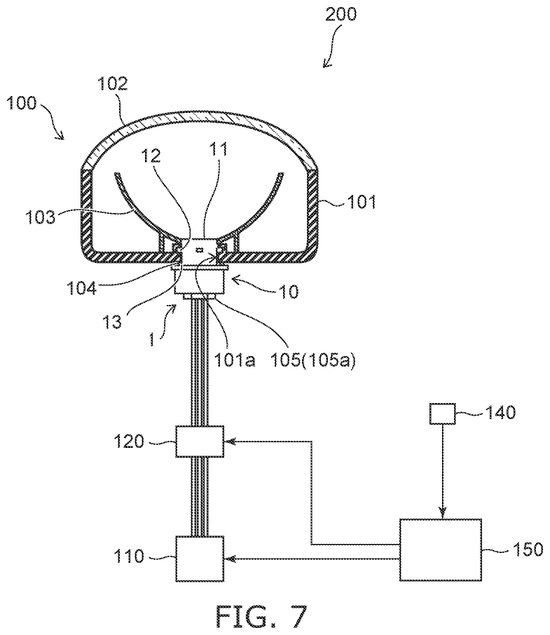

FIG. 7 is a schematic view illustrating the automatic driving vehicle lighting system 200.

As illustrated in FIG. 7, for example, the vehicle luminaire 1, the vehicle lighting tool 100, a power supply 110, a switching circuit 120, an input unit 140, and a controller 150 can be provided in the automatic driving vehicle lighting system 200.

For example, the housing 101, a cover 102, an optical element unit 103, a sealing member 104, and the connector 105 are provided in the vehicle lighting tool 100.

The vehicle luminaire 1 is attached to the housing 101. The housing 101 holds the mounting part 11. The housing 101 has a box shape in which one end side is opened. For example, the housing 101 can be formed from a resin or the like through which light is not transmitted. An attachment hole 101a, into which a portion of the mounting part 11 where the bayonet 12 is provided is inserted, is provided in a bottom surface of the housing 101. A concave part, into which the bayonet 12 provided in the mounting part 11 is inserted, is provided in a peripheral edge of the attachment hole 101a. Note that, description was given of a case where the attachment hole 101a is directly provided in the housing 101, but an attaching member including the attachment hole 101a may be provided in the housing 101.

When attaching the vehicle luminaire 1 to the vehicle lighting tool 100, the portion of the mounting part 11 where the bayonet 12 is provided is inserted into the attachment hole 101a, and the vehicle luminaire 1 is rotated. In this case, the bayonet 12 is held to a fitting portion provided in the peripheral edge of the attachment hole 101a. This attachment method is referred to as twist-lock.

The cover 102 is provided to cover an opening of the housing 101. The cover 102 can be formed from a resin or the like having translucency. The cover 102 can also be set to have a function of a lens or the like.

Light emitted from the vehicle luminaire 1 is incident to the optical element unit 103. The optical element unit 103 carries out reflection, diffusion, guiding, condensing, formation of a predetermined luminous intensity distribution pattern, and the like with respect to the light emitted from the vehicle luminaire 1. For example, the optical element unit 103 illustrated in FIG. 7 is a reflector. In this case, the optical element unit 103 reflects the light emitted from the vehicle luminaire 1 to form a predetermined luminous intensity distribution pattern.

The sealing member 104 is provided between the flange 13 and the housing 101. The sealing member 104 can have an annular shape. The sealing member 104 can be formed from a material such as a rubber and a silicone resin which have elasticity.

The connector 105 can be fitted to the ends of the power-supply terminals 31a to 31c exposed to the inside of the connector holder 15. The connector 105 is electrically connected to the switching circuit 120. In addition, the sealing member 105a is provided in the connector 105. When the connector 105 is inserted to the inside of the connector holder 15, the inside of the connector holder 15 is water-tightly sealed by the sealing member 105a.

The power supply 110 applies a voltage to the vehicle luminaire 1. The power supply 110 can be set as a DC power supply such as a battery. In addition, the power supply 110 can also cause the voltage applied to the vehicle luminaire 1 to vary.

The switching circuit 120 is electrically connected between the connector 105 (vehicle luminaire 1) and the power supply 110. The switching circuit 120 applies a voltage to at least any one of the first light-emitting circuit 20a and the second light-emitting circuit 20b on the basis of a signal transmitted from the controller 150.

The input unit 140 transmits information relating to brightness outside a vehicle to the controller 150. For example, the input unit 140 can be set as an optical sensor that detects brightness outside the vehicle, a camera provided in a drive recorder, or the like. In addition, the input unit 140 can collect information relating to the brightness outside the vehicle, for example, time for discriminating night and day, weather for discriminating sunny, rainy, and cloudy, geographic information such as a position of tunnel, and the like, through the Internet or the like and can also transmit the information to the controller 150.

For example, the controller 150 can be set as a computer. The controller 150 controls elements provided in the vehicle and performs automatic driving. In addition, when performing automatic driving, the controller 150 displays a driving state of the vehicle. For example, when performing automatic driving, the controller 150 lights the vehicle luminaire 1. For example, when lighting the vehicle luminaire 1, the controller 150 controls the switching circuit 120 on the basis of the information relating to brightness outside the vehicle. For example, in an environment in which the outside of the vehicle is dark, the controller 150 controls the switching circuit 120 to apply a voltage to the second light-emitting circuit 20b. In an environment in which the outside of the vehicle is bright, the controller 150 controls the switching circuit 120 to apply a voltage to the first light-emitting circuit 20a or to apply a voltage to the first light-emitting circuit 20a and the second light-emitting circuit 20b. In addition, the controller 150 can blink the vehicle luminaire 1, can cause a period of the blinking to vary, can cause brightness to vary, or can combine the blinking and the variation of brightness, for example, in correspondence with a driving aspect of the vehicle.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. An automatic driving vehicle luminaire configured to display a driving state of an automatic driving vehicle, comprising:
a socket; and
a light-emitting module provided on one end side of the socket,
the light-emitting module emits bluish green light.

2. The luminaire according to claim 1, further comprising:
a first power-supply terminal electrically connected to the light-emitting module; and
a second power-supply terminal electrically connected to the light-emitting module,
wherein the light-emitting module includes,
a first light-emitting circuit including a plurality of first light-emitting elements connected in series, and
a second light-emitting circuit including a small number of second light-emitting elements in comparison to the number of the first light-emitting elements,
an anode side of the first light-emitting circuit is electrically connected to the first power-supply terminal,
an anode side of the second light-emitting circuit is electrically connected to the second power-supply terminal,
when the outside of a vehicle is first brightness, a voltage is applied to the second power-supply terminal, and
when the outside of the vehicle is second brightness brighter than the first brightness, a voltage is applied to the first power-supply terminal, or the first power-supply terminal and the second power-supply terminal.

3. The luminaire according to claim 1,
wherein the first light-emitting circuit further includes a current control unit connected to the plurality of first light-emitting elements in series, and
the current control unit controls a value of a current flowing through the plurality of first light-emitting elements in correspondence with a voltage applied to the first power-supply terminal.

4. The luminaire according to claim 1,
wherein the second light-emitting circuit further includes a film-shaped resistor connected to the second light-emitting elements in series.

5. The luminaire according to claim 1,
wherein the number of the first light-emitting elements located on a downward side of an approximately horizontal line segment passing through a central axis of the socket is larger than the number of the first light-emitting elements located on an upward side of the line segment.

6. The luminaire according to claim 1,
wherein the bluish green color is a color in a region surrounded by a line connecting chromaticity coordinates T1 and chromaticity coordinates T2, a line connecting the chromaticity coordinates T2 and chromaticity coordinates T3, a line connecting the chromaticity coordinates T3 and chromaticity coordinates T4, and a line connecting the chromaticity coordinates T4 and the chromaticity coordinates T1 in an XY chromaticity diagram, and
the chromaticity coordinates T1 are (0, 0.55), the chromaticity coordinates T2 are (0.25, 0.45), the chromaticity coordinates T3 are (0.25, 0.27), and the chromaticity coordinates T4 are (0, 0.27).

7. The luminaire according to claim 1,
wherein the bluish green color is a color in a region surrounded by a line connecting chromaticity coordinates T1 and chromaticity coordinates T2, a line connecting the chromaticity coordinates T2 and chromaticity coordinates T3, a line connecting the chromaticity coordinates T3 and chromaticity coordinates T4, and a line connecting the chromaticity coordinates T4 and the chromaticity coordinates T1 in an XY chromaticity diagram, and
the chromaticity coordinates T1 are (0.012, 0.495), the chromaticity coordinates T2 are (0.2, 0.4), the chromaticity coordinates T3 are (0.2, 0.32), and the chromaticity coordinates T4 are (0.04, 0.32).

8. The luminaire according to claim 2, further comprising:
a phosphor to which light emitted from the first light-emitting element is incident,
wherein the first light-emitting element is a blue light-emitting diode, and
the phosphor is a mixture of a blue light-emitting phosphor and a green light-emitting phosphor, or a bluish green light-emitting phosphor.

9. The luminaire according to claim 2, further comprising:
a phosphor to which light emitted from the second light-emitting element is incident,
wherein the second light-emitting element is a blue light-emitting diode, and
the phosphor is a mixture of a blue light-emitting phosphor and a green light-emitting phosphor, or a bluish green light-emitting phosphor.

10. The luminaire according to claim 2,
wherein the first light-emitting element is a light-emitting diode configured to emit the bluish green light.

11. The luminaire according to claim 2,
wherein the second light-emitting element is a light-emitting diode configured to emit the bluish green light.

12. The luminaire according to claim 2,
wherein when the outside of the vehicle is the first brightness, a voltage is not applied to the first power-supply terminal.

13. The luminaire according to claim 2,
wherein when the outside of the vehicle is the second brightness and a voltage is applied to only the first power-supply terminal, a voltage is not applied to the second power-supply terminal.

14. The luminaire according to claim 3,
wherein the current control unit is a constant-current control circuit.

15. The luminaire according to claim 2, further comprising:
a third power-supply terminal electrically connected to a ground side of the first light-emitting circuit, and a ground side of the second light-emitting circuit.

16. An automatic driving vehicle lighting system comprising:
the automatic driving vehicle luminaire according to claim 1; and
a vehicle lighting tool to which the automatic driving vehicle luminaire is attached.

17. The system according to claim 16, further comprising:
a power supply configured to apply a voltage to the automatic driving vehicle luminaire;
a switching circuit electrically connected between the automatic driving vehicle luminaire and the power supply; and
a controller configured to control the switching circuit on the basis of information relating to brightness outside a vehicle.

18. The system according to claim 17,
wherein the automatic driving vehicle luminaire includes,
a first light-emitting circuit including a plurality of first light-emitting elements connected in series, and
a second light-emitting circuit including a small number of second light-emitting elements in comparison to the number of the first light-emitting elements,
when the outside of a vehicle is first brightness, the controller controls the switching circuit to apply a voltage to the second light-emitting circuit,
when the outside of the vehicle is second brightness brighter than the first brightness, the controller controls the switching circuit to apply a voltage to the first light-emitting circuit or to apply a voltage to the first light-emitting circuit and the second light-emitting circuit.

19. The system according to claim 16,
wherein the vehicle lighting tool is a front combination light or a rear combination light.

20. The system according to claim 16,
wherein the vehicle lighting tool is installed in at least one of a bonnet, a roof, a pillar, a bumper, a fender, and a rearview mirror.
